(19) United States
(12) Patent Application Publication
(10) Pub. No.: US 2023/0410368 A1
(43) Pub. Date: Dec. 21, 2023

(54) METHOD FOR LEARNING NETWORK PARAMETER OF NEURAL NETWORK, METHOD FOR CALCULATING CAMERA PARAMETER, AND COMPUTER-READABLE RECORDING MEDIUM RECORDING A PROGRAM

(71) Applicant: Panasonic Intellectual Property Corporation of America, Torrance, CA (US)

(72) Inventor: Nobuhiko WAKAI, Tokyo (JP)

(73) Assignee: Panasonic Intellectual Property Corporation of America, Torrance, CA (US)

(21) Appl. No.: 18/238,688

(22) Filed: Aug. 28, 2023

Related U.S. Application Data
(63) Continuation of application No. PCT/JP2022/008302, filed on Feb. 28, 2022.
(60) Provisional application No. 63/156,606, filed on Mar. 4, 2021.

(30) Foreign Application Priority Data
Aug. 25, 2021 (JP) 2021-137002

(51) Int. Cl. G06T 7/80

(52) U.S. Cl. CPC G06T 7/80; G06T 2207/30244; G06T 2207/20081; G06T 2207/20084

(57) ABSTRACT

Provided is a method for learning a network parameter of a neural network including, by an information processor: acquiring a learning image; acquiring a true camera parameter related to the learning image; calculating a true two-dimensional coordinate point by projecting a three-dimensional coordinate point on a unit spherical surface onto a predetermined plane by using the true camera parameter; calculating an estimated two-dimensional coordinate point by projecting the three-dimensional coordinate point onto the predetermined plane by using the estimated camera parameter estimated by the neural network; and learning the network parameter of the neural network based on a distance between the true two-dimensional coordinate point and the estimated two-dimensional coordinate point.

### TECHNICAL FIELD

The present disclosure relates to a method for learning a network parameter of a neural network, a method for calculating a camera parameter, and a computer-readable recording medium recording a program.

### BACKGROUND ART

Non-Patent Literatures 1 and 2 below each disclose a calculation device of a camera parameter according to a background art.

Unfortunately, the background art disclosed in Non-Patent Literature 1 cannot easily calculate a camera parameter. Additionally, the background art disclosed in Non-Patent Literature 2 is insufficient in calculation accuracy of a camera parameter.

### CITATION LIST

### Non Patent Literature

Non-Patent Literature 1: R. Y. Tsai. “A versatile camera calibration technique for high accuracy 3D machine vision metrology using off-the-shelf TV cameras and lenses. IEEE Journal of Robotics and Automation, Volume 3, Number 4, pages 323-344, 1987
Non-Patent Literature 2: M. Lopez, R. Mari, P. Gargallo, Y. Kuang, J. Gonzalez-Jimenez, and G. Haro. “Deep single image camera calibration with radial distortion”, In Proceedings of IEEE Conference on Computer Vision and Pattern Recognition, pages 11809-11817, 2019

### SUMMARY OF INVENTION

It is an object of the present disclosure to provide a method for learning a network parameter of a neural network, a method for calculating a camera parameter, and a computer-readable recording medium recording a program, which are capable of easily and accurately calculating a camera parameter.

### Means for Solving the Problems

A method for learning a network parameter of a neural network according to one aspect of the present disclosure includes, by an information processor: acquiring a learning image; acquiring a true camera parameter related to the learning image; calculating a true two-dimensional coordinate point by projecting a three-dimensional coordinate point on a unit spherical surface onto a predetermined plane by using the true camera parameter; calculating an estimated two-dimensional coordinate point by projecting the three-dimensional coordinate point onto the predetermined plane by using the estimated camera parameter estimated by the neural network; and learning the network parameter of the neural network based on a distance between the true two-dimensional coordinate point and the estimated two-dimensional coordinate point.

### BRIEF DESCRIPTION OF DRAWINGS

FIG. 1 is a diagram illustrating a simplified configuration of a camera parameter calculation device according to a first embodiment of the present disclosure.

FIG. 2 is a flowchart illustrating a flow of processing performed by a camera parameter calculation device.

FIG. 3 is a flowchart illustrating a flow of a method for learning a network parameter in a deep neural network (DNN).

FIG. 4 is a flowchart illustrating details of processing of calculating loss.

FIG. 5 is a flowchart illustrating details of processing of calculating loss.

FIG. 6 is a diagram for illustrating a difference between the first embodiment of the present disclosure and the background art.

FIG. 7 is a flowchart illustrating details of processing of calculating loss according to a second embodiment of the present disclosure.

### DESCRIPTION OF EMBODIMENTS

(Underlying Knowledge of Present Disclosure)

Camera calibration of a sensing camera or the like performed by a geometry-based method requires a three-dimensional coordinate value in a three-dimensional space to be associated with a pixel position in a two-dimensional image. To achieve this, a three-dimensional coordinate value and a pixel position in a two-dimensional image are associated with each other by photographing a repetitive pattern in a known shape and detecting a position of an intersection, a center position of a circle, or the like (Non-Patent Literature 1).

Additionally, a deep learning-based method is proposed as a robust learning method for image brightness, a subject, or the like using one input image (Non-Patent Literature 2).

Unfortunately, the method of Non-Patent Literature 1 requires performing: photographing of a repetitive pattern in a known shape; detecting a position of an intersection, a center position of a circle, or the like; and associating a three-dimensional coordinate value with a pixel position in a two-dimensional image, and thus, these operations are complicated.

In contrast, the method of Non-Patent Literature 2 expresses lens distortion with a simple polynomial using one first parameter for inferring the lens distortion by deep learning and a second parameter calculated by a quadratic function of the first parameter. Thus, large lens distortion cannot be appropriately expressed, so that calculation accuracy of a camera parameter is insufficient when this method is applied to calibration of a camera with large lens distortion such as a fisheye camera.

To solve the problems described above, the present inventors have found that a camera parameter can be easily and accurately calculated by devising a method of projecting a three-dimensional coordinate point on a unit spherical surface and a two-dimensional coordinate point on a predetermined plane, and have conceived of the present disclosure.

Next, each aspect of the present disclosure will be described.

A method for learning a network parameter of a neural network according to one aspect of the present disclosure includes, by an information processor: acquiring a learning image; acquiring a true camera parameter related to the learning image; calculating a true two-dimensional coordinate point by projecting a three-dimensional coordinate point on a unit spherical surface onto a predetermined plane by using the true camera parameter; calculating an estimated two-dimensional coordinate point by projecting the three-dimensional coordinate point onto the predetermined plane by using the estimated camera parameter estimated by the neural network; and learning the network parameter of the neural network based on a distance between the true two-dimensional coordinate point and the estimated two-dimensional coordinate point.

The present aspect enables the learning of the network parameter of the neural network to be simply and accurately performed, so that a camera parameter can be easily and accurately calculated.

A method for learning a network parameter of a neural network according to one aspect of the present disclosure includes, by an information processor: acquiring a learning image; acquiring a true camera parameter related to the learning image; calculating a true two-dimensional coordinate point by projecting a three-dimensional coordinate point on a unit spherical surface onto a predetermined plane by using the true camera parameter; calculating an estimated three-dimensional coordinate point by projecting the true two-dimensional coordinate point onto the unit spherical surface by using the estimated camera parameter estimated by the neural network; and learning the network parameter of the neural network based on a distance between the three-dimensional coordinate point and the estimated three-dimensional coordinate point.

The present aspect enables the learning of the network parameter of the neural network to be simply and accurately performed, so that a camera parameter can be easily and accurately calculated.

In the above aspect, the three-dimensional coordinate point is each of a plurality of three-dimensional coordinate points generated in a uniform distribution with respect to an incident angle of the camera.

The present aspect enables learning accuracy of the network parameter to be further improved by using the plurality of three-dimensional coordinate points.

In the above aspect, the camera parameter includes a plurality of parameters, and the estimated camera parameter is a composite camera parameter in which one parameter of the plurality of parameters is an estimated parameter and another parameter of the plurality of parameters is a true parameter.

The present aspect enables the learning accuracy of the network parameter to be further improved by using the composite parameter.

In the above aspect, in the learning of the network parameter, the information processor learns the network parameter so as to minimize the distance.

The present aspect enables the learning accuracy of the network parameter to be further improved by performing the learning for minimizing the distance between the true coordinate point and the estimated coordinate point.

A method for calculating a camera parameter according to one aspect of the present disclosure includes, by an information processor: acquiring a target image; calculating a camera parameter of the target image based on a neural network in which a network parameter is learned, the network parameter being learned by the method for learning a network parameter of a neural network according to the above aspect; and outputting the camera parameter.

The present aspect enables the learning of the network parameter of the neural network to be simply and accurately performed, so that a camera parameter can be easily and accurately calculated.

A computer-readable recording medium recording a program according to one aspect of the present disclosure causes an information processor to function as: acquisition means; and calculation means, the acquisition means acquires a learning image; and acquires a true camera parameter regarding the learning image, and the calculation means calculates a true two-dimensional coordinate point by projecting a three-dimensional coordinate point on a unit spherical surface onto a predetermined plane using the true camera parameter; calculates an estimated two-dimensional coordinate point by projecting the three-dimensional coordinate point onto the predetermined plane using the estimated camera parameter estimated by a neural network; and learns a network parameter of the neural network based on a distance between the true two-dimensional coordinate point and the estimated two-dimensional coordinate point.

The present aspect enables the learning of the network parameter of the neural network to be simply and accurately performed, so that a camera parameter can be easily and accurately calculated.

A computer-readable recording medium recording a program according to one aspect of the present disclosure causes an information processor to function as acquisition means and calculation means, the acquisition means acquires a learning image; and acquires a true camera parameter regarding the learning image, and the calculation means calculates a true two-dimensional coordinate point by projecting a three-dimensional coordinate point on a unit spherical surface onto a predetermined plane using the true camera parameter; calculates an estimated three-dimensional coordinate point by projecting the true two-dimensional coordinate point on the unit spherical surface using an estimated camera parameter estimated by a neural network; and learns a network parameter of the neural network based on a distance between the three-dimensional coordinate point and the estimated three-dimensional coordinate point.

The present aspect enables the learning of the network parameter of the neural network to be simply and accurately performed, so that a camera parameter can be easily and accurately calculated.

Hereinafter, embodiments of the present disclosure will be described in detail with reference to the drawings. Elements denoted by the same reference numerals in different drawings represent the same or corresponding elements.

Each of the embodiments described below illustrates a specific example of the present disclosure. Numerical values, shapes, components, steps, order of steps, and the like shown in the following embodiments are merely examples, and are not intended to limit the present disclosure. The components in the following embodiments include a component that is not described in an independent claim indicating the highest concept and that is described as an arbitrary component. All the embodiments have respective contents that can be combined.

### First Embodiment

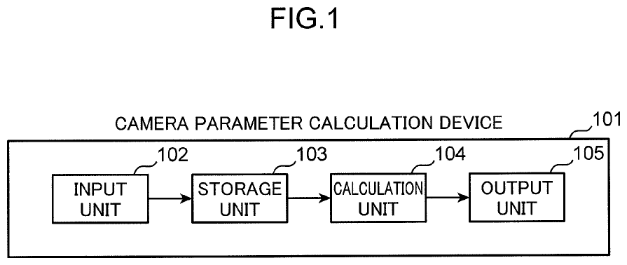

FIG. 1 is a diagram illustrating a simplified configuration of a camera parameter calculation device 101 according to a first embodiment of the present disclosure. The camera parameter calculation device 101 includes an input unit 102, a storage unit 103 such as a frame memory, a calculation unit 104 such as a CPU, and an output unit 105. The input unit 102, the calculation unit 104, and the output unit 105 can be implemented as functions obtained by a processor such as a CPU executing a program read out from a recording medium such as a CD-ROM to a ROM or a RAM. Alternatively, the input unit 102, the calculation unit 104, and the output unit 105 may be configured using dedicated hardware.

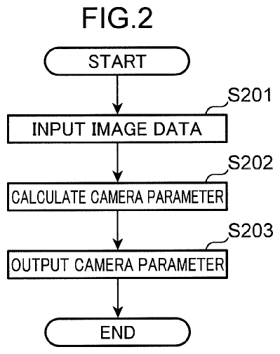

FIG. 2 is a flowchart illustrating a flow of processing performed by the camera parameter calculation device 101. First, in step S201, the input unit 102 acquires image data on an image (target image) captured by a camera, which is a calibration target of a camera parameter, from the camera, an appropriate recording medium, or the like. The input unit 102 stores the acquired image data in the storage unit 103.

Next, in step S202, the calculation unit 104 reads out the image data on the target image from the storage unit 103. The calculation unit 104 calculates the camera parameter of the target image by inputting the image data on the target image to a learned deep neural network (DNN). Details of a method for learning a network parameter in the DNN will be described later.

Subsequently, in step S203, the output unit 105 outputs the camera parameters calculated by the calculation unit 104.

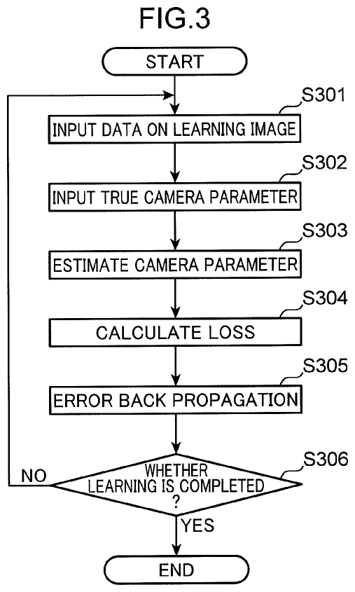

FIG. 3 is a flowchart illustrating a flow of a method for learning a network parameter in the DNN. First, in step S301, the calculation unit 104 inputs image data on a learning image used for learning of the DNN. The learning image is captured in advance with a fisheye camera or the like. Alternatively, the learning image may be generated by computer graphics (CG) processing from a panorama image using a fisheye camera model.

Next, in step S302, the calculation unit 104 inputs a true camera parameter Ω-hat. The true camera parameter Ω-hat relates to a camera that has captured the learning image. However, when the learning image is generated by the CG processing, the true camera parameter Ω-hat has been used for the CG processing. Camera parameters include an external parameter that relates to an attitude of the camera (rotation and translation with respect to the world coordinate reference) and an internal parameter that relates to a focal length, lens distortion, or the like.

Subsequently, in step S303, the calculation unit 104 inputs the learning image to the DNN to estimate (infer) a camera parameter Ω. The DNN extracts a feature value of an image from a convolutional layer or the like, and outputs each camera parameter finally estimated. For example, three estimated camera parameters Ω of a tilt angle ψ, a roll angle xv, and a focal length f of the camera are output. For simplicity of description, an example of estimating the three camera parameters (θ, ψ, f) will be described below.

Subsequently, in step S304, the calculation unit 104 calculates a loss Lₜₒₜₐₗ that is an error of an estimation result of the DNN to learn the network parameter of the DNN. Details of the processing in step S304 will be described later.

Subsequently, in step S305, the calculation unit 104 updates the network parameter of the DNN by an error back propagation method. As an optimization algorithm in the error back propagation method, a stochastic gradient descent can be used, for example.

Subsequently, in step S306, the calculation unit 104 determines whether the learning of the DNN is completed. The calculation unit 104 determines that the learning is completed when the number of times of updating the network parameter of the DNN exceeds a threshold value (e.g., 10,000 times) or when the loss Lₜₒₜₐₗ calculated in step S304 has a value less than a threshold value (e.g., three pixels).

When the learning is completed (YES in step S306), the processing ends. When the learning is not completed (NO in step S306), the processing in step S301 and subsequent steps are repeatedly performed.

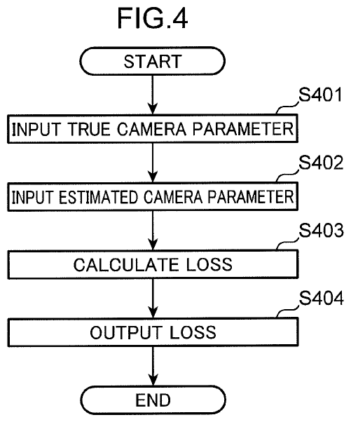

FIG. 4 is a flowchart illustrating details of the processing of calculating the loss Lₜₒₜₐₗ in step S304. First, in step S401, the calculation unit 104 inputs the true camera parameter a-hat acquired in step S302.

Next, in step S402, the calculation unit 104 inputs the estimated camera parameter Q estimated in step S303.

Subsequently, in step S403, the calculation unit 104 calculates the loss Lₜₒₜₐₗ according to Equation (1) below.

[Formula 1]

Lₜₒₜₐₗ=w_{θ}L_{θ}+w_{ψ}L_{ψ}+w_{f}L_{f} (1)

w_{θ}, w_{ψ}, and w_{f} are weights for the tilt angle, the roll angle, and the focal length, respectively. For example, the weights w_{θ}, w_{ψ}, and w_{f} are each “1”. Alternatively, when camera parameters are distinguished by importance, the weights w_{θ}, w_{ψ}, and w_{f} may be different in value from each other. Then, L_{θ}, L_{ψ}, and L_{f} are losses L in the tilt angle, the roll angle, and the focal length, respectively.

Subsequently, in step S404, the calculation unit 104 outputs the loss Lₜₒₜₐₗ calculated in step S403.

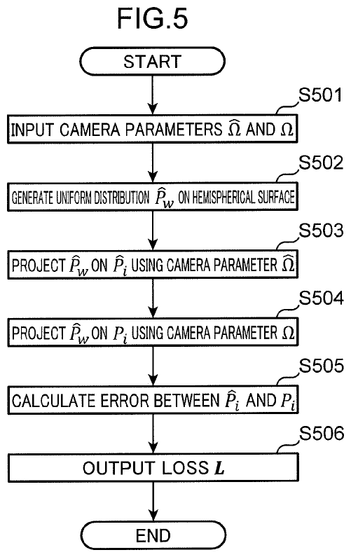

FIG. 5 is a flowchart illustrating details of the processing of calculating the loss Lₜₒₜₐₗ in step S403. First, in step S501, the calculation unit 104 inputs the true camera parameter Ω-hat and the estimated camera parameter Ω. The estimated camera parameter Ω is generated as a composite camera parameter in which only one parameter of the plurality of parameters θ, ψ, and f is replaced with an estimated parameter and true parameters are used for the remaining two parameters. For example, when only the tilt angle θ is replaced with the estimated parameter, the estimated parameter in the DNN is used for the tilt angle θ, and the true parameters are used for the roll angle ψ and the focal length f. As a result, a loss L_{θ} that is an error in the tilt angle θ is expressed.

Next, in step S502, the calculation unit 104 defines a spherical surface of a unit circle with a camera position as an origin, and cuts out a hemispherical surface S having an incident angle of 90° or less. Alternatively, when a fisheye camera model (e.g., stereographic projection) capable of handling an incident angle of 90° or more is used, the incident angle may be 90° or more. The calculation unit 104 generates N three-dimensional coordinate points P_{w}-hat having a uniform distribution on the hemispherical surface S. This uniform distribution can be generated by applying a uniform random number to each of two angles in three-dimensional polar coordinate representation (radius, angle 1, angle 2). Then, N has a value of 10,000, for example.

Subsequently, in step S503, the calculation unit 104 calculates a true two-dimensional coordinate point Pᵢ-hat by projecting a true three-dimensional coordinate point P_{w}-hat onto a predetermined image plane (hereinafter referred to as a “predetermined plane”) using the true camera parameter Ω-hat. The camera parameter is a parameter to be projected from world coordinates to image coordinates. The stereographic projection, which is an example of the fisheye camera model, is expressed by Equations (2) to (5).

$$[ Formula 2 ]$$

$$[ \begin{matrix}x \\ y \\ 1\end{matrix} ] = [ \begin{matrix}γ f / {d}_{x} & 0 & {C}_{x} & 0 \\ 0 & γ f / {d}_{y} & {C}_{y} & 0 \\ 0 & 0 & 0 & 1\end{matrix} ] [ \begin{matrix}{X}_{e} \\ {Y}_{e} \\ {Z}_{e} \\ 1\end{matrix} ] \qquad ( 2 )$$

$$[ Formula 3 ]$$

$$[ \begin{matrix}{X}_{e} \\ {Y}_{e} \\ {Z}_{e} \\ 1\end{matrix} ] = [ \begin{matrix}{r}_{1 l} & {r}_{l 2} & {r}_{13} & {T}_{X} \\ {r}_{21} & {r}_{22} & {r}_{23} & {T}_{Y} \\ {r}_{31} & {r}_{32} & {r}_{33} & {T}_{Z} \\ 0 & 0 & 0 & 1\end{matrix} ] [ \begin{matrix}X \\ Y \\ Z \\ 1\end{matrix} ] \qquad ( 3 )$$

$$[ Formula 4 ]$$

$$γ = 2 tan ( \frac{ϕ}{2} ) \qquad ( 4 )$$

$$[ Formula 5 ]$$

$$ϕ = arctan ( \frac{\sqrt{{X}_{e}^{2} + {Y}_{e}^{2}}}{{Z}_{e}} ) \qquad ( 5 )$$

Here, (X, Y, Z) is world coordinate values of the true three-dimensional coordinate point P_{w}-hat, and (x, y) is image coordinate values of the true two-dimensional coordinate point Pᵢ-hat. The camera has a focal length indicated as f, and principal image coordinates indicated as (Cₓ, C_{y}). Components of a rotation matrix of “3×3” representing rotation with respect to the world coordinate reference are indicated as r₁₁ to r₃₃, and translation with respect to the world coordinate reference is indicated as T_{X}, T_{Y}, or T_{Z}.

Subsequently, in step S504, the calculation unit 104 calculates an estimated two-dimensional coordinate point Pᵢ by projecting the true three-dimensional coordinate point P_{w}-hat onto the predetermined plane using the estimated camera parameter n.

Subsequently, in step S505, the calculation unit 104 calculates the loss L based on an error between the true two-dimensional coordinate point Pᵢ-hat and the estimated two-dimensional coordinate point Pᵢ. The error can be defined as the square of the Euclidean distance between the true two-dimensional coordinate point Pᵢ-hat and the estimated two-dimensional coordinate point Pᵢ, and thus an average of N points generated in a uniform distribution is calculated as shown in Equation (6) below.

$$[ Formula 6 ]$$

$$L ( Ω , \hat{Ω} ) = \frac{1}{N} {\sum }_{k = 1}^{N} {‖ {P}_{i , k} - {\hat{P}}_{i , k} ‖}_{2}^{2} \qquad ( 6 )$$

Then, an error function for calculating the loss L is not limited to the example of Equation (6), and a Huber loss or the like expressed by Equation (7) below may be used.

$$[ Formula 7 ]$$

$$L ( Ω , \hat{Ω} ) = \frac{1}{N} {\sum }_{k = 1}^{N} \{ \begin{matrix}\frac{1}{2} {‖ {P}_{i , k} - {\hat{P}}_{i , k} ‖}_{2}^{2} & if {‖ {P}_{i , k} - {\hat{P}}_{i , k} ‖}_{2} \leq 0.5 \\ {‖ {P}_{i , k} - {\hat{P}}_{i , k} ‖}_{2} - 0.5 & otherwise\end{matrix} \qquad ( 7 )$$

Subsequently, in step S506, the calculation unit 104 outputs the loss L calculated in step S505.

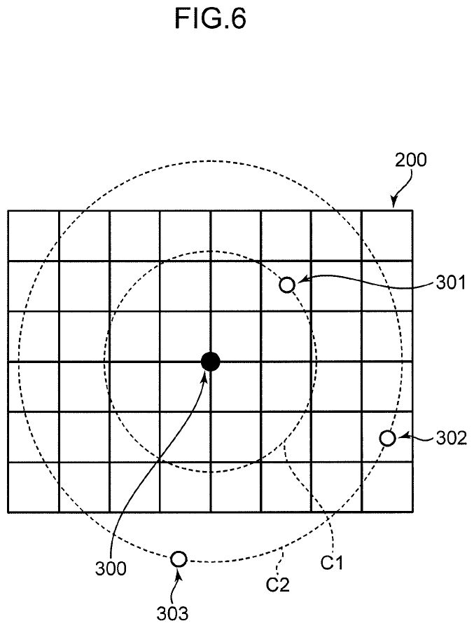

FIG. 6 is a diagram for illustrating a difference between the present embodiment and Non-Patent Literature 2. Non-Patent Literature 2 discloses a method for estimating a camera parameter using a DNN as with that of the present embodiment, and deep learning is performed using loss described in Non-Patent Literature 2 (referred to as Bearing Loss in the literature). Unlike the loss L of the present embodiment, the Bearing Loss selects pixel values of all pixels of an image (grid points on the image), projects each grid point on the unit spherical surface of the world coordinates using camera parameters, and defines a distance on the unit spherical surface as an error. As illustrated in FIG. 6, grid points on an image 200 of Non-Patent Literature 2 are not uniform at a distance (image height) from a principal point 300, and an incident angle is also not uniform (the incident angle depends on the image height). For example, a grid point 301 exists on a circle C1 that is close to the principal point 300 and has a first distance from the principal point 300, and a grid point 302 exists on a circle C2 that is far from the principal point 300 and has a second distance from the principal point 300. Thus, when grid points are selected from the rectangular image, selected pixels become non-uniform such as including a grid point 303 that exists in a part of the circle C2 having a large distance from the principal point, the part protruding outside the image 200, and that does not exist on the image 200. Additionally, a large image height (corresponding to the large circle C2 in FIG. 6) increases the number of selected grid points (increased in proportion to the square of the image height) more than a small image height (corresponding to the small circle C1 in FIG. 6). The image height corresponds to the incident angle one by one in a camera model that is symmetric with respect to an optical axis, so that the incident angle increases as the image height increases. That is, a large incident angle causes biased sampling. As described above, the Bearing Loss based on a point using an image grid is non-uniform sampling and is not suitable for a fisheye camera model with large lens distortion.

In contrast, the loss L according to the present embodiment is calculated in which an error is calculated by projecting a point serving as a projection source having a uniform distribution with respect to an incident angle on image coordinates using a camera parameter, so that the loss L is suitable for learning the camera parameter of not only a normal camera with small lens distortion but also a fisheye camera with large lens distortion.

### Second Embodiment

Hereinafter, a second embodiment of the present disclosure will be described focusing on a difference from the first embodiment.

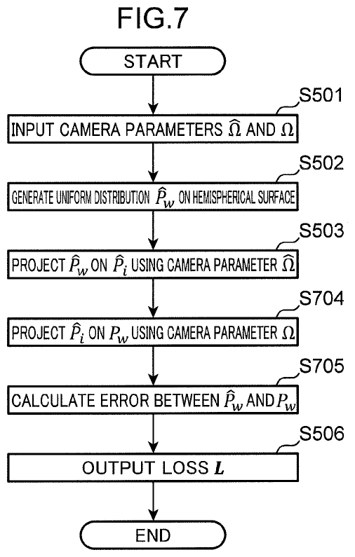

FIG. 7 is a flowchart illustrating details of processing of calculating loss Lₜₒₜₐₗ according to the second embodiment of the present disclosure and corresponding to FIG. 5. First, in step S501, the calculation unit 104 inputs the true camera parameter Ω-hat and the estimated camera parameter Ω.

Next, in step S502, the calculation unit 104 defines a spherical surface of a unit circle with a camera position as an origin, cuts out a hemispherical surface S having an incident angle of 90° or less, and generates N three-dimensional coordinate points P_{w}-hat having a uniform distribution on the hemispherical surface S.

Subsequently, in step S503, the calculation unit 104 calculates a true two-dimensional coordinate point Pᵢ-hat by projecting a true three-dimensional coordinate point P_{w}-hat on a predetermined plane using a true camera parameter Ω-hat.

Subsequently, in step S704, the calculation unit 104 calculates an estimated three-dimensional coordinate point P, by projecting the true two-dimensional coordinate point Pᵢ-hat on the hemispherical surface S using an estimated camera parameter Ω. Equations (2) to (5) described above are not only for projecting the three-dimensional coordinate point P_{w} onto the two-dimensional coordinate point Pᵢ using the camera parameter Ω, but also for projecting the two-dimensional coordinate point Pᵢ of the image coordinates onto the three-dimensional coordinate point P_{w} of the world coordinates using the camera parameter Ω. The image coordinates are two-dimensional and the world coordinates are three-dimensional. Thus, when the two-dimensional coordinate point Pᵢ is projected onto the three-dimensional coordinate point P_{w}, unique world coordinates can be obtained by limiting the image coordinates to the world coordinates on the unit spherical surface (hemispherical surface S).

Subsequently, in step S705, the calculation unit 104 calculates the loss L based on an error between the true three-dimensional coordinate point P_{w}-hat and the estimated three-dimensional coordinate point P_{w}. The error can be defined as the square of the Euclidean distance between the true three-dimensional coordinate point P_{w}-hat and the estimated three-dimensional coordinate point P_{w}, and thus an average of N points generated in a uniform distribution is calculated as shown in Equation (8) below.

$$[ Formula 8 ]$$

$$L ( Ω , \hat{Ω} ) = \frac{1}{N} {\sum }_{k = 1}^{N} {‖ {P}_{w , k} - {\hat{P}}_{w , k} ‖}_{2}^{2} \qquad ( 8 )$$

Then, an error function for calculating the loss L is not limited to the example of Equation (8), and a Huber loss or the like expressed by Equation (9) below may be used.

$$[ Formula 9 ]$$

$$L ( Ω , \hat{Ω} ) = \frac{1}{N} {\sum }_{k = 1}^{N} \{ \begin{matrix}\frac{1}{2} {‖ {P}_{w , k} - {\hat{P}}_{w , k} ‖}_{2}^{2} & if {‖ {P}_{w , k} - {\hat{P}}_{w , k} ‖}_{2} \leq 0.5 \\ {‖ {P}_{w , k} - {\hat{P}}_{w , k} ‖}_{2} - 0.5 & otherwise\end{matrix} \qquad ( 9 )$$

Subsequently, in step S506, the calculation unit 104 outputs the loss L calculated in step S705.

As with the first embodiment above, the present embodiment also enables the learning of the network parameter of the neural network to be simply and accurately performed, so that a camera parameter can be easily and accurately calculated. The present embodiment causes an error to have a maximum value suppressed within a diameter (=1) of the unit spherical surface, and thus enables obtaining an effect that learning is less likely to fail than in the first embodiment at an initial stage of learning in which a network parameter is not determined. In contrast, the first embodiment causes learning for minimizing an error on a two-dimensional image to be performed, and thus has a higher effect of removing image distortion by calibration of a camera parameter than the present embodiment.

### INDUSTRIAL APPLICABILITY

The present disclosure is particularly useful for application to a camera parameter calculation device for a camera with large lens distortion such as a fisheye camera.

1. A method for learning a network parameter of a neural network, the method comprising, by an information processor:
acquiring a learning image;
acquiring a true camera parameter related to the learning image;
calculating a true two-dimensional coordinate point by projecting a three-dimensional coordinate point on a unit spherical surface onto a predetermined plane by using the true camera parameter;
calculating an estimated two-dimensional coordinate point by projecting the three-dimensional coordinate point onto the predetermined plane by using the estimated camera parameter estimated by the neural network; and
learning the network parameter of the neural network based on a distance between the true two-dimensional coordinate point and the estimated two-dimensional coordinate point.

2. The method for learning a network parameter of a neural network according to claim 1,
wherein the three-dimensional coordinate point is each of a plurality of three-dimensional coordinate points generated in a uniform distribution with respect to an incident angle of a camera.

3. The method for learning a network parameter of a neural network according to claim 1, wherein
the camera parameter includes a plurality of parameters, and
the estimated camera parameter is a composite camera parameter in which one parameter of the plurality of parameters is an estimated parameter and another parameter of the plurality of parameters is a true parameter.

4. The method for learning a network parameter of a neural network according to claim 1, wherein in the learning of the network parameter, the information processor learns the network parameter so as to minimize the distance.

5. A method for learning a network parameter of a neural network, the method comprising, by an information processor:
acquiring a learning image;
acquiring a true camera parameter related to the learning image;
calculating a true two-dimensional coordinate point by projecting a three-dimensional coordinate point on a unit spherical surface onto a predetermined plane by using the true camera parameter;
calculating an estimated three-dimensional coordinate point by projecting the true two-dimensional coordinate point onto the unit spherical surface by using the estimated camera parameter estimated by the neural network; and
learning the network parameter of the neural network based on a distance between the three-dimensional coordinate point and the estimated three-dimensional coordinate point.

6. The method for learning a network parameter of a neural network according to claim 5, wherein the three-dimensional coordinate point is each of a plurality of three-dimensional coordinate points generated in a uniform distribution with respect to an incident angle of a camera.

7. The method for learning a network parameter of a neural network according to claim 5, wherein
the camera parameter includes a plurality of parameters, and
the estimated camera parameter is a composite camera parameter in which one parameter of the plurality of parameters is an estimated parameter and another parameter of the plurality of parameters is a true parameter.

8. The method for learning a network parameter of a neural network according to claim 5, wherein in the learning of the network parameter, the information processor learns the network parameter so as to minimize the distance.

9. A method for calculating a camera parameter, the method comprising, by an information processor:
acquiring a target image;
calculating a camera parameter of the target image based on a neural network in which a network parameter is learned,
the network parameter being learned by the method for learning a network parameter of a neural network according to claim 1; and
outputting the camera parameter.

10. A method for calculating a camera parameter, the method comprising, by an information processor:
acquiring a target image;
calculating a camera parameter of the target image based on a neural network in which a network parameter is learned,
the network parameter being learned by the method for learning a network parameter of a neural network according to claim 5; and
outputting the camera parameter.

11. A computer-readable recording medium recording a program that causes an information processor to function as:
acquisition means; and
calculation means,
the acquisition means
acquires a learning image; and
acquires a true camera parameter regarding the learning image, and
the calculation means
calculates a true two-dimensional coordinate point by projecting a three-dimensional coordinate point on a unit spherical surface onto a predetermined plane using the true camera parameter;
calculates an estimated two-dimensional coordinate point by projecting the three-dimensional coordinate point onto the predetermined plane using the estimated camera parameter estimated by a neural network; and
learning a network parameter of the neural network based on a distance between the true two-dimensional coordinate point and the estimated two-dimensional coordinate point.

12. A computer-readable recording medium recording a program that causes an information processor to function as:
acquisition means; and
calculation means,
the acquisition means
acquires a learning image; and
acquires a true camera parameter regarding the learning image; and
the calculation means
calculates a true two-dimensional coordinate point by projecting a three-dimensional coordinate point on a unit spherical surface onto a predetermined plane using the true camera parameter;
calculates an estimated three-dimensional coordinate point by projecting the true two-dimensional coordinate point on the unit spherical surface using an estimated camera parameter estimated by a neural network; and
learns a network parameter of the neural network based on a distance between the three-dimensional coordinate point and the estimated three-dimensional coordinate point.
